(19) United States
(12) Patent Application Publication
(10) Pub. No.: US 2021/0213839 A1
(43) Pub. Date: Jul. 15, 2021

(54) WIRELESS POWER TRANSFER DEVICE

(71) Applicants: Hyundai Motor Company, Seoul (KR); Kia Motors Corporation, Seoul (KR); Myongji University Industry and Academia Cooperation Foundation, Yongin (KR)

(72) Inventors: Jae Yong Seong, Hwaseong (KR); Min Ho Shin, Yongin (KR)

(21) Appl. No.: 17/145,810

(22) Filed: Jan. 11, 2021

Related U.S. Application Data
(60) Provisional application No. 62/982,233, filed on Feb. 27, 2020.
(60) Provisional application No. 62/959,470, filed on Jan. 10, 2020.

(51) Int. Cl. B60L 53/126; B60L 53/38; B60L 53/36; H02J 50/80; H02J 50/90; H02J 50/12

(52) U.S. Cl. CPC B60L 53/126; B60L 53/38; B60L 53/36; H02J 2310/48; H02J 50/90; H02J 50/12; H02J 50/80

(57) ABSTRACT

The present disclosure provides a wireless power transfer device simplifying the communication interface between a high level component and a low level component centralize loads of the wireless power transfer system and minimize any delay that may arise in processing communication messages, and increase an efficiency of the charging process. The wireless power transfer device supplies energy to an electric vehicle through an EV device in the electric vehicle. The wireless power transfer device includes a supply power circuit that forms a magnetic flux from source power and supplies the energy to the EV device through the magnetic flux. A SECC configured communicates with the EV device and a supply WPTCC performs a P2PS communication with the EV device, under a control of the SECC, transmits and receives data required for positioning, pairing, and alignment checks and operates the supply power circuit.

### CROSS-REFERENCE TO RELATED APPLICATION

The present application claims the benefit of priority to U.S. Provisional Patent Applications No. 62/959,470 filed on Jan. 10, 2020 and No. 62/982,223 filed on Feb. 27, 2020 with the U.S. Patent and Trademark Office, the entire contents of which are incorporated herein by reference.

### TECHNICAL FIELD

The present disclosure relates to a wireless charging device for an electric vehicle and, more particularly, to a supply device and an electric vehicle device of a wireless power transfer system for use in wireless charging of an electric vehicle.

### BACKGROUND

An electric vehicle is driven by an electric motor powered by a battery and has advantages of reducing pollutants such as exhaust gas and noise, less breakdown, longer life, and simpler driving operation. The electric vehicle charging system may be defined as a system that charges a battery mounted in an electric vehicle using electric power acquired from a commercial power grid or energy storage device. According to conventional conductive charging systems, the electric vehicle is able be charged by extending a cable or robot arm with a connector at a front end thereof, and coupling the connector to a charging socket of the vehicle, and applying power through the cable or robot arm. However, a wireless power transfer (WPT) system is attracting attention in a viewpoint of the economy and charging convenience in consideration of user's waiting time during the charging.

When charging the electric vehicle by the wireless power transfer, the electric vehicle is positioned proximate to and aligned with a charging spot by use of a low frequency (LF) signal, a low power excitation (LPE) signal, or received signal strength indication (RSSI) and is powered by a magnetic induction, magnetic resonance, or electromagnetic waves. The International Organization for Standardization (ISO) has completed standardization with an ISO 15118 series for ‘Vehicle to grid communication interface’, and the International Electrotechnical Commission (IEC) is in a process of standardizing the wireless power transfer (WPT) system in IEC 61980 series.

According to a conventional system configuration established, power supply from a supply power circuit (SPC) of a supply device to an electric vehicle power circuit (EVPC) of the electric vehicle (EV) is controlled by a supply equipment communication controller (SECC) and an EV communication controller (EVCC). The SECC and the EVCC communicate with each other by transmitting and receiving signals through a point-to-point signal (P2PS) controller for vehicle positioning, pairing, and alignment check while performing direct communication through a wireless communication interface such as a wireless LAN (WLAN).

In the WPT system, the SECC and the EVCC receive charging and monitoring signals related with the WPT from the SPC and the EVPC, respectively, control the power circuits, i.e. the SPC and the EVPC, perform communications through the wireless communication interface, and operate the P2PS controller to transmit and receive signals for the vehicle positioning, pairing, and alignment check. When the EVCC and the SECC perform only the transmission and reception of the charging and monitoring signals related with the WPT, it may be efficient for the EVCC and the SECC to execute the wireless power transfer operation. The various functions and operations of the SECC and the EVCC, however, may be burdensome for the SECC and the EVCC for themselves and may degrade an efficiency of the system. For example, when the vehicle positioning has started and is in progress, the SECC or the EVCC have to await a completion of a data handling at a lower level and then manipulate the data before sending to its counterpart via a wireless communication interface. Accordingly, a delay in processing the communication message may increase while the positioning or the alignment check operation is performed.

### SUMMARY

Provided is a wireless power transfer device simplifying the communication interface between a high level component and a low level component and decentralizing loads of the high level component to minimize any delay that may arise in processing communication messages and increase an efficiency of the charging process.

According to an aspect of an exemplary embodiment, provided is a wireless power transfer device for supplying energy to an electric vehicle through an EV device in the electric vehicle. The wireless power transfer device may include: a supply power circuit configured to form a magnetic flux from source power and supply the energy to the EV device through the magnetic flux; a supply device communication controller (SECC) configured to communicate with the EV device; and a supply wireless power transfer communication controller (WPTCC) configured to perform a peer-to-peer signal (P2PS) communication with the EV device, under a control of the SECC, to transmit and receive data required for positioning, pairing, and alignment check and control the supply power circuit. The SECC may be configured to perform a communication with the EV device in an application layer.

Operations performed in the supply power circuit and controlled by the supply WPTCC may include: ‘turning on’, ‘turning off’, ‘entering sleep mode’, ‘wake up from sleep mode’, ‘start wireless charging’, and ‘stop wireless charging. The P2PS communication with the EV device may be performed using at least one of a low frequency magnetic field (LF) signal and a low power excitation (LPE) signal.

The supply WPTCC may be configured to receive commands related to positioning, pairing, and alignment check from the SECC to perform the P2PS communication in response to the commands. The supply power circuit may include: a supply power electronics circuit configured to convert a frequency and level of the supply power and cause a resonance to occur; and a primary device configured to receive a converted power signal from the supply power electronics circuit and form the magnetic flux. The supply WPTCC may be configured to directly adjust the supply power electronics circuit. The SECC and the supply WPTCC may separately include a first and a second processors, respectively.

The supply WPTCC may include: at least one LF receiver configured to receive an LF signal from the EV device; at least one LPE transmitter configured to transmit an LPE signal to the EV device; the second processor; and a memory configured to store at least one instruction executable by the second processor. The at least one instruction may include: an instruction for interfacing communications with the SECC; an instruction for receiving the LF signal through the at least one LF receiver and transmitting the LPE signal through the at least one LPE transmitter; and an instruction for operating the supply power circuit.

According to an aspect of an exemplary embodiment, provided is a wireless power transfer device installed in an electric vehicle for receiving energy from an external supply device to charge an energy storage device. The wireless power transfer device may include: an EV power circuit configured to receive the energy from the supply device through a magnetic flux to convert to electrical power and charge the energy storage device; an EV communication controller (EVCC) configured to communicate with the supply device; and an EV wireless power transfer communication controller (WPTCC) configured to perform a peer-to-peer signal (P2PS) communication with the supply device, under an operation of the EVCC, to transmit and receive data required for positioning, pairing, and alignment check and operate the EV power circuit.

The EVCC may be configured to perform a communication with the supply device in an application layer. Operations performed in the EV power circuit and controlled by the EV WPTCC may include: ‘turning on’, ‘turning off’, ‘entering sleep mode’, ‘wake up from sleep mode’, ‘start wireless charging’, and ‘stop wireless charging. The P2PS communication with the supply device may be performed using at least one of a low frequency magnetic field (LF) signal and a low power excitation (LPE) signal.

The EV WPTCC may be configured to receive commands related to positioning, pairing, and alignment check from the EVCC to perform the P2PS communication in response to the commands. The EV power circuit may include: a secondary device configured to convert the magnetic flux to an induction power signal; and an EV power electronics circuit configured to convert a level of the induction power signal and rectify a level-converted signal to charge the energy storage device. The EV WPTCC may be configured to directly operate the EV power electronics circuit.

The EVCC and the EV WPTCC may separately include a first and a second processors, respectively. The EV WPTCC may include: at least one LF transmitter configured to transmit an LF signal to the supply device; at least one LPE receiver configured to receive an LPE signal from the supply device; the second processor; and a memory configured to store at least one instruction executable by the second processor. The at least one instruction may include: an instruction for interfacing communications with the EVCC; an instruction for transmitting the LF signal through the at least one LF transmitter and receiving the LPE signal through the at least one LPE receiver; and an instruction for operating the EV power circuit.

According to an exemplary embodiment of the present disclosure, lower-level communication components (i.e. the EV WPTCC and the supply WPTCC) are disposed between the high-level communication components (i.e. the EVCC and the SECC) and the wireless power transfer components (i.e. the EV power circuit and the supply power circuit). Since the communication interfaces between the upper level components and the corresponding lower level components are simplified and the loads of the lower-level communication components are distributed, the delay in processing communication messages is minimized and the efficiency of the charging process may be improved.

Unlike a conventional system in which the alignment check operation, for example, is performed only after the vehicle positioning and pairing operations are completed, the vehicle positioning, pairing, and alignment check operations may be performed simultaneously according to an exemplary embodiment of the present disclosure. As a result, the present disclosure improves the performance of the WPT system and reduces manufacturing costs and operation cost of the system. Additionally, the present disclosure enhances the convenience of users of the charging station.

Furthermore, the alignment technology of the present disclosure will be helpful in the development of an autonomous parking or a remote parking system in combination with an autonomous driving technology. Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 illustrates a concept of a wireless power transfer (WPT) for an electric vehicle to which exemplary embodiments of the present disclosure are applied;

FIG. 2 is an illustration of a power flow in the WPT according to an exemplary embodiment of the present disclosure;

FIG. 3 is a block diagram of a wireless power transfer system according to an exemplary embodiment of the present disclosure;

FIG. 4 is a detailed block diagram of a supply power circuit and an EV power circuit shown in FIG. 3;

FIG. 5 is a detailed block diagram of a supply WPT communication controller and an EV WPT communication controller shown in FIG. 3;

FIG. 6 is a table summarizing functions performed based on communications between a supply WPTCC and a supply power circuit;

FIG. 7 is a table summarizing functions performed by a supply WPT communication controller according to commands from a SECC;

FIG. 8 is a waveform diagram of an exemplary on-off keying (OOK) modulated signal;

FIG. 9 is a waveform diagram showing an example of a current in a transmitter coil and a received signal detected by a receiver in case that the OOK modulation is performed for an LF signal;

FIG. 10 is a physical block diagram of the supply WPTCC according to an exemplary embodiment of the present disclosure;

FIG. 11 is an illustration for explaining a concept of an exemplary vehicle positioning and alignment using the LF signal; and

FIG. 12 is a flowchart illustrating an example of a wireless power transfer (WPT) process according to an exemplary embodiment of the present disclosure.

The drawings described herein are for illustration purposes only and are not intended to limit the scope of the present disclosure in any way.

### DETAILED DESCRIPTION

For a more clear understanding of the features and advantages of the present disclosure, exemplary embodiments of the present disclosure will be described in detail with reference to the accompanied drawings. However, it should be understood that the present disclosure is not limited to particular embodiments and includes all modifications, equivalents, and alternatives falling within the idea and scope of the present disclosure. In describing each drawing, similar reference numerals have been used for similar components.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure.

The terminologies are used herein for the purpose of describing particular embodiments only and are not intended to limit the disclosure. The singular forms include plural referents unless the context clearly dictates otherwise. Also, the expressions “˜ comprises,” “˜ includes,” “˜ constructed,” “˜ configured” are used to refer a presence of a combination of enumerated features, numbers, processing steps, operations, elements, or components, but are not intended to exclude a possibility of a presence or addition of another feature, number, processing step, operation, element, or component.

The terms used in this application are only used to describe certain embodiments and are not intended to limit the present disclosure. As used herein, the singular expressions are intended to include plural forms as well, unless the context clearly dictates otherwise. It should be understood that the terms “comprise” and/or “comprising”, when used herein, specify the presence of stated features, integers, steps, operations, elements, components, or a combination thereof but do not preclude the presence or addition of one or more features, integers, steps, operations, elements, components, or a combination thereof.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with meanings in the context of related technologies and should not be interpreted as having ideal or excessively formal meanings unless explicitly defined in the present application.

Hereinafter, embodiments of the present disclosure will be described in more detail with reference to the accompanying drawings. In describing the present disclosure, in order to facilitate an overall understanding thereof, the same components are assigned the same reference numerals in the drawings and are not redundantly described here. Hereinafter, exemplary embodiments of the present disclosure will be described in detail with reference to the accompanying drawings.

In the following description and the accompanied drawings, detailed descriptions of well-known functions or configuration that may obscure the subject matter of the present disclosure will be omitted for simplicity. Also, it is to be noted that the same components are designated by the same reference numerals throughout the drawings.

Terms used in the present disclosure are defined as follows.

According to exemplary embodiments of the present disclosure, an EV charging system may be defined as a system for charging a high-voltage battery mounted in an EV using power of an energy storage device or a power grid of a commercial power source. The EV charging system may have various forms according to the type of EV. For example, the EV charging system may be classified as a conductive-type using a charging cable or a non-contact wireless power transfer (WPT)-type (also referred to as an “inductive-type”). The power source may include a residential or public electrical service or a generator utilizing vehicle-mounted fuel, and the like.

Terminologies used in the present disclosure are defined as follows.

“Electric Vehicle (EV)”: An automobile, as defined in 49 CFR 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be a four or more wheeled vehicle manufactured for use primarily on public streets or roads.

The EV may include an electric vehicle, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

“Wireless power charging system (WCS)”: The system for wireless power transfer and control of interactions including operations for an alignment and communications between a ground assembly (GA) and a vehicle assembly (VA) or between a primary device and a secondary device

“Wireless power transfer (WPT)”: The transfer of power from the alternating current (AC) supply network to the electric vehicle without contact.

“Interoperability”: A state in which components of a system interwork with corresponding components of the system to perform operations aimed by the system. Additionally, information interoperability may refer to capability that two or more networks, systems, devices, applications, or components may efficiently share and easily use information without causing inconvenience to users.

“Inductive charging system”: A system transferring energy from a power source to an EV via a two-part gapped core transformer in which the two halves of the transformer, i.e., primary and secondary coils, are physically separated from one another. In the present disclosure, the inductive charging system may correspond to an EV power transfer system.

“Inductive coupler”: The transformer formed by the coil in the GA Coil and the coil in the VA Coil that allows power to be transferred with galvanic isolation.

“Inductive coupling”: Magnetic coupling between two coils. In the present disclosure, coupling between the GA Coil and the VA Coil.

“Supply device”: An apparatus which provides the contactless coupling to the EV device. In other words, the supply device may be an apparatus external to an EV. When the EV is receiving power, the supply device may operate as the source of the power to be transferred. The supply device may include the housing and all covers.

“EV device”: An apparatus mounted on the EV which provides the contactless coupling to the supply device. In other words, the EV device may be installed within the EV. When the EV is receiving power, the EV device may transfer the power from the primary battery to the EV. The EV device may include the housing and all covers.

“Alignment”: A process of finding the relative position of supply device to EV device and/or finding the relative position of EV device to supply device for the efficient power transfer that is specified. In the present disclosure, the alignment may direct to a fine positioning of the wireless power transfer system.

“Pairing”: A process by which a vehicle is correlated with a dedicated supply device, at which the vehicle is located and from which the power will be transferred. Pairing may include the process by which a VA controller and a GA controller of a charging spot are correlated. The correlation/association process may include the process of association of a relationship between two peer communication entities.

“High-level communication (HLC)”: A special type of digital communication. HLC is necessary for additional services which are not covered by command and control communication. The data link of the HLC may use a power line communication (PLC), but the data link of the HLC is not limited to the PLC.

“Wireless local area network (WLAN)”: A local area network in which data are transferred without the use of wires

“WPT Session”: Collection of services around a charge point mainly related to the charging of an EV over WPT technology assigned to a specific customer in a specific timeframe with a unique identifier

“WPT charging spot”: WPT supply site with only one supply device

“WPT charging site”: A physical location of one or more WPT charging spots

“WPT communication controller” and “WPTCC”: A communication controller that controls P2PS communication interfaces and underlying power circuit and communicates with application-layer communication controllers such as EVCC and SECC

“Supply WPT communication controller”, “Supply WPPTCC”, and “SWCC”: A WPT communication controller in a supply device of the WPT system of the infrastructure

“EV WPT communication controller”, “EV WPTCC”, and “EWCC”: A WPT communication controller in an EV device of the WPT system in a vehicle

Hereinbelow, exemplary embodiments of the present disclosure will be described in detail with reference to the accompanied drawings.

System Architecture and Configurations

FIG. 1 illustrates a concept of wireless power transfer (WPT) for an electric vehicle to which exemplary embodiments of the present disclosure are applied. A wireless power transfer (WPT) for an electric vehicle may be defined as a transfer of electrical energy from a supply network, through an electric field, a magnetic field, and/or an electromagnetic field or wave, between a supplier side device and a consumer side device without any current flow over a galvanic connection. The WPT may be performed by a charging station 10 and at least one component of an electric vehicle (EV) 20, and may be used to charge the EV 20 by transmitting power from the charging station 10 to the EV 20.

The charging station 10 may be configured to receive electric power from a power grid 2 or a power backbone and supply power to the EV 20 through a power transmitter pad 11. The power transmitter pad 11 may be mounted on the ground in a parking space of the charging station 10 and a transmitter coil may be provided therein. The transmitter coil in the power transmitter pad 11 generates magnetic flux to supply magnetic energy amplified by a magnetic resonance to the EV 20. The charging station 10 may be located at various places including a parking lot attached to a house of an owner of the EV 20, a parking area for charging the EV at a gas station, and a parking area of a shopping center or a business building, for example but is not limited thereto.

The charging station 10 may be configured to communicate with an infrastructure management system or an infrastructure server that manages the power grid 2 or a power network via wired or wireless communications. Additionally, the charging station 10 may be configured to perform wireless communications with the EV 20. In particular, the wireless communications may include a wireless LAN (WLAN) based on WiFi and, as will be described below, peer-to-peer signal (P2PS) communications using a low frequency (LF) magnetic field signal and/or a low power excitation (LPE) signal. Further, the wireless communications between the charging station 10 and the EV 20 may include one or more of various communication schemes such as Bluetooth, Zigbee, and cellular network communications.

The EV 20 may be defined as an automobile driven by an electric motor that uses electrical energy stored in a rechargeable energy storage device such as a battery 22. The EV 20 according to exemplary embodiments of the present disclosure may include a hybrid vehicle (HEV) having both an electric motor and an internal combustion engine. In addition, the EV 20 may include not only an automobile but also a motorcycle, a cart, and a scooter, and an electric bicycle. The EV 20 may include a power reception pad 21 having a receiver coil to receive the magnetic energy wirelessly from the charging station 10. The receiver coil in the power reception pad 21 may be configured to receive the magnetic energy from the transmitter coil of the power transmitter pad 11 in the charging station 10 by the magnetic resonance, for example. The magnetic energy received by the EV 20 may be converted into an induced current, and the induced current may be rectified to a direct current (DC) to charge the battery 22.

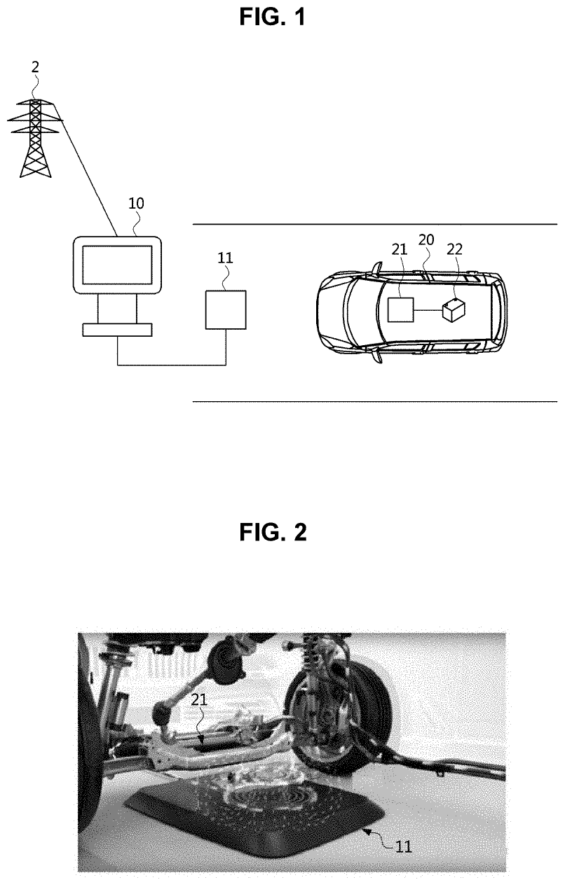

FIG. 2 is an illustration of a power flow in WPT according to an exemplary embodiment of the present disclosure. Referring to FIG. 2, the power transmitter pad 11 may be mounted on the ground in a parking space of the charging station 10, and the EV 20 may be aligned to the power transmitter pad 11 such that the reception pad 21 faces power the power transmitter pad 11. In this state, the magnetic energy may be transmitted from the ground-mounted power transmitter pad 11 to the power reception pad 21 of the EV 20 through a magnetic resonance, for example. In FIG. 2, the power flow is exaggerated to enhance understandability through a visualization, but it is noted that FIG. 2 is no more than a virtual rendering of a magnetic flux in space and the present disclosure is not limited thereto.

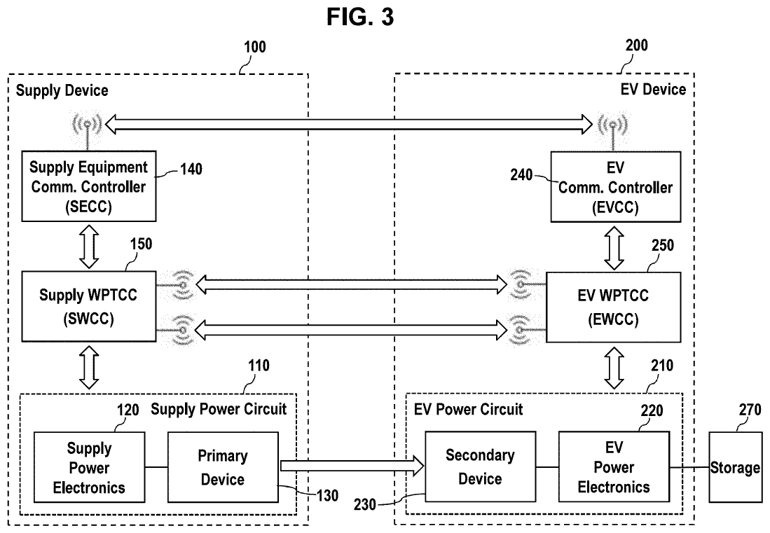

FIG. 3 is a block diagram of a wireless power transfer system according to an exemplary embodiment of the present disclosure. The wireless power transfer system may include a supply device 100 installed in the charging station 10 and an EV device 200 installed in the EV 20. The supply device 100 may include a supply power circuit 110, a supply equipment communication controller (SECC) 140, and a supply WPT communication controller (WPTCC) 150. The supply power circuit 110 may be configured to receive power supplied from the power grid 2, form a magnetic flux using received power, and supply energy to the EV 20 through the magnetic resonance. The supply power circuit 110 may include a supply power electronics circuit 120 and a primary device 130.

The supply power electronics circuit 120 may be configured to receive the power supplied from the power grid 2 and change a frequency and voltage level of an input voltage and current. In addition, the supply power electronics circuit 120 may cause a resonance to be generated between the primary device 130 and the EV device 200 to supply high power to the EV 20 through the primary device 130. In addition, the supply power electronics circuit 120 may be configured to execute an overall operation of the supply power circuit 110 including the primary device 130. For example, the supply power electronics circuit 120 may enable or disable an energy transmission to the EV device 200.

The primary device 130 may include a transmitter coil which generates a magnetic field by using the supplied power, to transfer magnetic energy of a high energy level to the EV 20 through the magnetic resonance. In one exemplary embodiment, the supply power circuit 110 may correspond to the transmitter pad 11 shown in FIGS. 1 and 2. The SECC 140, which is a higher-level controller, may be configured to communicate with and operate the supply WPTCC 150. In addition, the SECC may be configured to operate the supply power circuit 110 through the supply WPTCC 150. Further, the SECC 140 may be configured to communicate with an EV communication controller (EVCC) 240 in the EV device 200 through the WLAN. The SECC 140 and the EVCC 240 control application layer communications, of OSI layers 3 and higher, in the WPT system according to an ISO standard 15118-20:2020. The physical and data link layer, of OSI layers 1 and 2, of the WLAN link is compatible with an ISO standard 15118-8.

The supply WPTCC 150 may be configured to perform the P2PS communication with a corresponding component in the EV device 200 under a control of the SECC 140. In this specification including the claims, the P2PS communication refers to a communication for transmitting and receiving a signal for charging the EV by using a low frequency (LF) magnetic field signal and/or a low power excitation (LPE) signal. Meanwhile, the supply WPTCC 150 operates the supply power circuit 110 to facilitate and accurately control the wireless power transfer from the supply device 100 to the EV device 200.

Meanwhile, the EV device 200 may include an EV power circuit 210, the EV communication controller (EVCC) 240, and an EV WPT communication controller (WPTCC) 250. The EV power circuit 210 may be configured to energy from the supply power circuit 110 of the supply device 100 in a form of a magnetic flux fluctuation, convert received magnetic energy into an induced current, and rectify the induced current into a DC current to charge the storage device 270, e.g. the battery 22. The EV power circuit 210 may include an EV power electronics circuit 220 and a secondary device 230.

The secondary device 230 may include a receiver coil, which captures the fluctuating magnetic flux induced from the primary device 130 to receive magnetic energy of a high energy level supplied in a magnetic resonant state, for example. In an exemplary embodiment, the EV power circuit 210 may correspond to the receiver pad 21 shown in FIGS. 1 and 2. The EV power electronics circuit 220 may be configured to receive the received power signal output by the secondary device 230 and change a frequency and voltage level of the signal. Additionally, the EV power electronics circuit 220 may cause the resonance to be generated between the primary device 130 and the secondary device 230 to supply high power to the EV 20 from the primary device 130. The EV power electronics circuit 220 may be configured to execute an overall operation of the EV power circuit 210 including the secondary device 230. For example, the EV power electronics circuit 220 may enable or disable an energy reception from the supply power circuit 110 of the supply device 100.

The EVCC 240 communicates with and operates the EV WPTCC 250. In addition, the EVCC 240 may be configured to operate the EV power circuit 210 through the EV WPTCC 250. Further, the EVCC 240 may be configured to communicate with the SECC 140 in the supply device 100 through the WLAN. As mentioned above, the EVCC 240 and the SECC 140 control application layer communications, of OSI layers 3 and higher, in the WPT system according to an ISO standard 15118-20:2020. The physical and data link layer, of OSI layers 1 and 2, of the WLAN link is compatible with an ISO standard 15118-8. The EV WPTCC 250 may be configured to perform the P2PS communication with the supply WPTCC 150 in the supply device 100 under a control of the EVCC 240. Meanwhile, the EV WPTCC 250 may be configured to operate the EV power circuit 210 to facilitate and accurately control the wireless power transfer from the supply device 100 to the EV device 200.

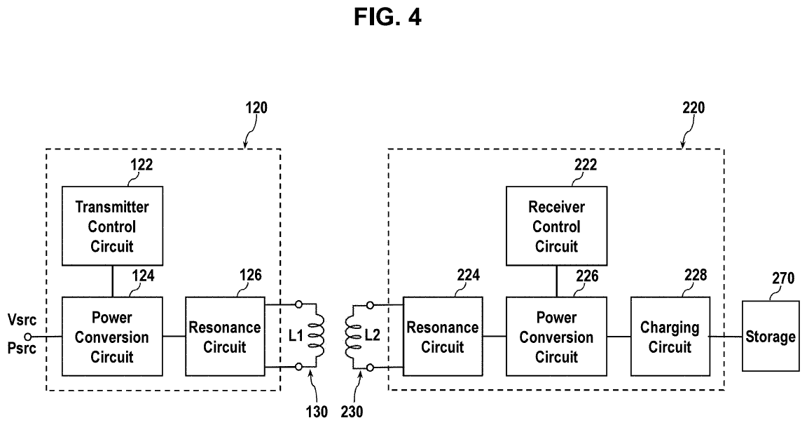

FIG. 4 is a detailed block diagram of the supply power circuit 110 and the EV power circuit 210 shown in FIG. 3. As mentioned above, the supply power circuit 110 in the supply device 100 may include the supply power electronics circuit 120 and the primary device 130. The EV power circuit 210 in the EV device 200 may include the EV power electronics circuit 220 and the secondary device 230.

The supply power electronics circuit 120 may include a transmitter control circuit 122, a power conversion circuit 124, and a resonance circuit 126. The transmitter control circuit 122 may be configured to execute the overall operation of the supply power circuit 110 including the primary device 130. In particular, the transmitter control circuit 122 may enable or disable the energy transmission to the EV device 200. The power conversion circuit 124 may be configured to receive a power Psrc corresponding to a supply voltage Vsrc supplied from the power grid 2 and change the frequency and voltage level of the voltage to facilitate an emission of an electromagnetic field at a desired resonance frequency from the primary device 130. The resonant circuit 126 may include a capacitor which the resonance frequency, together with the transmitter coil L1 in the primary device 120, at which the wireless power transfer between the primary device 130 and the secondary device 230 is maximized. Though the resonance circuit 126 is depicted as being provided in the supply power electronics circuit 120 in FIG. 4, the resonance circuit 126 may be considered as being provided in the primary device 130. The primary device 130 may correspond to the transmitter pad 11 shown in FIGS. 1 and 2 and includes a transmitter coil L1.

Meanwhile, in the EV device 200, the secondary device 230 may correspond to the receiver pad 21 shown in FIGS. 1 and 2 and includes a receiver coil L2. The transmitter coil L1 of the primary device 130 and the receiver coil of the secondary device 230 may be electromagnetically coupled. In a state that the transmitter coil L1 and the receiver coil L2 are electromagnetically coupled, a large-scale power transfer may be performed between the transmitter coil L1 of the primary device 130 and the receiver coil L2 of the secondary device 230 and a substantial amount of power may be induced to the receiver coil L2. Thus, the power transfer may have the same meaning as that power is induced to the secondary device 230 through the electromagnetic coupling.

The EV power electronics circuit 220 may include a receiver control circuit 222, a resonance circuit 224, a power conversion circuit 226, and a charging circuit 228. The receiver control circuit 222 may be configured to execute the overall operation of the EV power circuit 210 including the secondary device 230. In particular, the receiver control circuit 222 may enable or disable the energy reception from the supply power circuit 110. The resonance circuit 224 may include a capacitor which forms the resonance frequency, together with the receiver coil L2 in the secondary device 230, at which the wireless power transfer between the primary device 130 and the secondary device 230 is maximized. The power conversion circuit 226 may be configured to change the frequency and voltage level of the power which is input through the resonance circuit 224. The charging circuit 228 may be configured to rectify and filter the output signal of the power conversion circuit 226 to convert into a DC signal and charge the storage device 270, i.e. the battery 22 by a DC current. Though the resonance circuit 224 is depicted as being provided in the EV power electronics circuit 220 in FIG. 4, the resonance circuit 224 may be considered as being provided in the secondary device 230.

Resonant frequencies of the primary device 130 and the secondary device 230 may be configured to be the same as each other. On the other hand, as the transmitter coil L1 and the receiver coil L2 are located farther away, a power loss increases and a power transfer efficiency is reduced. Therefore, the two coils L1 and L2 are aligned and arranged to be proximate to each other through positioning and alignment, which are described below, to transfer maximum energy to the receiver coil L2 through the magnetic flux generated by the transmitter coil L1. Notably, the configuration of FIG. 4 should be understood as an example of the power transfer system applicable for embodiments of the present disclosure, and the present disclosure is not limited to the configuration of FIG. 4.

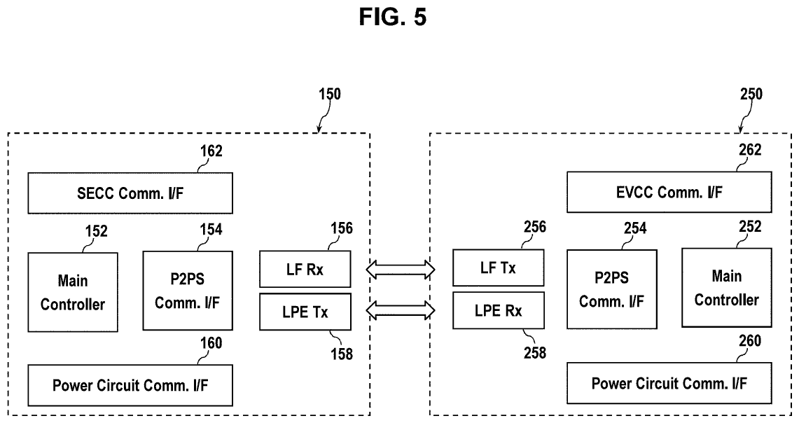

FIG. 5 is a detailed block diagram of the supply WPT communication controller 150 and the EV WPT communication controller 250 shown in FIG. 3. The supply WPT communication controller 150 may include a controller 152, a P2PS communication interface 154, at least one LF receiver 156, at least one LPE transmitter 158, a power circuit communication interface 160, and an SECC communication interface 162. The controller 152 may be configured to execute an overall operation of the supply WPT communication controller 150.

The P2PS communication interface 154 enables the supply WPTCC 150 to communicate with the EV WPTCC 250. As mentioned above, the P2PS communication refers to a transmission and/or reception of signals for charging the EV using the low frequency (LF) magnetic field signal and/or the low output excitation (LPE) signal. According to an exemplary embodiment of the present disclosure, the P2PS communication interface 158 supports at least one type of the P2PS interfaces: LF and LPE. Each type of P2PS interface requires two unidirectional P2PS interfaces. The LF signal is a digitally modulated magnetic field having a frequency in an ultra-low or low frequency ranges (i.e. LF and VLF bands of 3 kHz to 300 kHz) among the radio bands divided by the International Telecommunication Union (ITU).

In an exemplary embodiment, the LF signal may be transmitted by the EV WPT communication controller 250 and received by the supply WPT communication controller 150, while the LPE signal is transmitted by the supply WPT communication controller 150 and received by the EV WPT communication controller 250. The LF receiver 156 may be configured to receive and demodulate the LF signal transmitted by the LF transmitter 256 of the EV WPT communication controller 250 and provide a demodulated signal to the P2PS communication interface 158. The LPE transmitter 158 may be configured to generate and transmit an LPE signal for data which the P2PS communication interface 154 transmits to the P2PS communication interface 254 of the EV device 200.

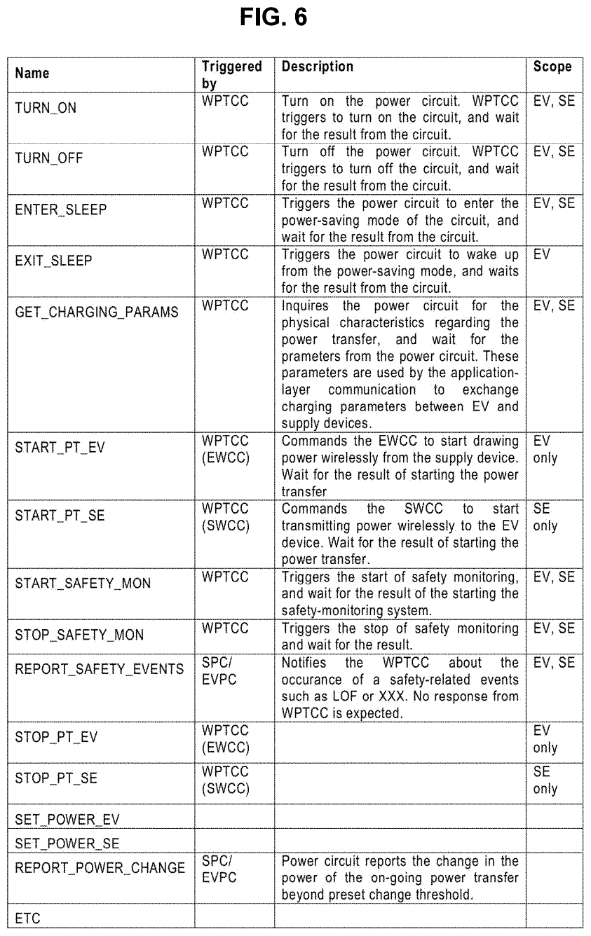

The power circuit communication interface 160 may be configured to operate the supply power circuit 110 to facilitate the wireless power transfer from the supply device 100 to the EV device 200. Possible communication schemes applicable to the power circuit communication interface 160 include a serial communication, Ethernet, and a CAN communication, but the present disclosure is not limited thereto. FIG. 6 is a table summarizing functions performed based on communications between the supply WPTCC 150 and the supply power circuit 110 through the power circuit communication interface 160. In the drawing, functions of which ‘scope’ are denoted by “EV, SE” or “SE only” are those associated with the supply WPTCC 150. As shown in the drawing, the supply WPTCC 150 may control various functions such as turning on and off of the supply power circuit 110, entering and wakening from a sleep mode, acquiring charging parameters, starting a wireless charging, starting and ending a safety monitoring, and stopping the wireless charging.

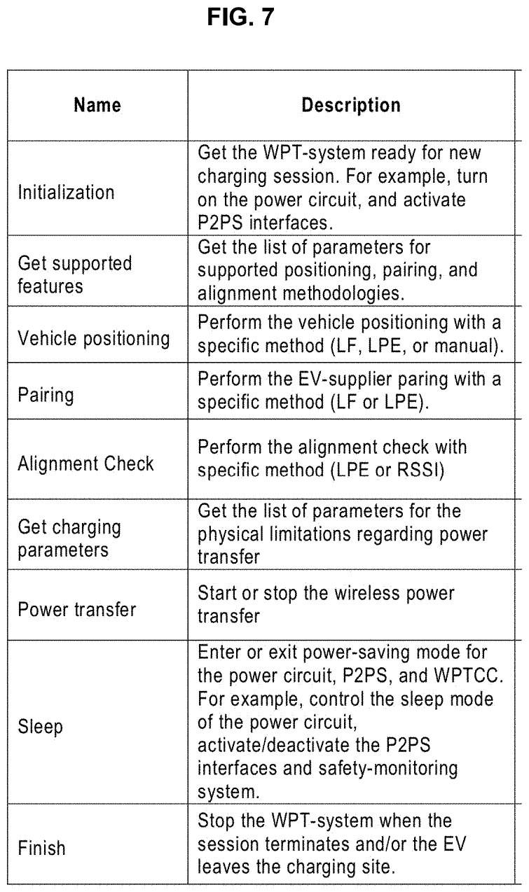

The SECC communication interface 162 allows the controller 152 to receive a control command from the SECC 140. The supply WPTCC 150 may be configured to receive various commands from the SECC 140, which is an application layer communication controller, to perform relevant functions such as safety check, parameter check, vehicle positioning, pairing, and alignment check related to the wireless power transfer according to received commands. Possible communication schemes applicable to the SECC communication interface 162 include the serial communication, Ethernet, and the CAN communication, but the present disclosure is not limited thereto. FIG. 7 is a table summarizing functions performed by the supply WPT communication controller 150 according to commands from the SECC 140 received through the SECC communication interface 162.

Meanwhile, the EV WPT communication controller 250 may include a controller 252, a P2PS communication interface 254, at least one LF transmitter 256, at least one LPE receiver 258, and a power circuit communication interface 260, and an EVCC communication interface 262. The controller 252 may be configured to execute an overall operation of the EV WPT communication controller 250.

The P2PS communication interface 254 enables the EV WPT communication controller 250 to communicate with the supply WPT communication controller 250. According to an exemplary embodiment of the present disclosure, the P2PS communication interface 258 supports at least one type of the P2PS interface: LF and LPE. Each type of P2PS interface requires two unidirectional P2PS interfaces. The LF transmitter 256 may be configured to generate and transmit an LF signal for data which the P2PS communication interface 254 transmits to the P2PS communication interface 154 of the supply device 100. The LPE receiver 258 may be configured to receive and demodulate the LPE signal transmitted by the P2PS communication interface 158 of the supply device 100, and provide the demodulated signal to the P2PS communication interface 258.

The power circuit communication interface 160 may be configured to operate the EV power circuit 110 to facilitate the wireless power transfer from the supply device 100 to the EV device 200. Possible communication schemes applicable to the power circuit communication interface 260 include the serial communication, Ethernet, and the CAN communication, but the present disclosure is not limited thereto. The functions of which ‘scope’ is denoted by “EV, SE” or “EV only” in FIG. 6 are what the EV WPTCC 250 can control for the power circuit 210. The EV WPTCC 250 can control various functions such as turning on and off of the power circuit 210, entering and wakening from a sleep mode, acquiring charging parameters, starting a wireless charging, starting and ending a safety monitoring, and stopping the wireless charging.

The EVCC communication interface 262 allows the controller 252 to receive a control command from the EVCC 240. The EV WPTCC 250 may be configured to receive various commands from the EVCC 240, which is an application layer communication controller, to perform relevant functions such as the safety check, parameter check, vehicle positioning, pairing, and alignment check related to the wireless power transfer according to received commands. Possible communication schemes applicable to the EVCC communication interface 262 include the serial communication, Ethernet, and the CAN communication, but the present disclosure is not limited thereto. The table of FIG. 7 also includes functions performed by the EV WPT communication controller 250 according to commands from the EVCC 240 received through the EVCC communication interface 262.

Meanwhile, any one of a large variety of modulation schemes may be chosen and implemented in the LF system. For binary shift-keying, an amplitude of a signal is changed between two levels to represent a binary bit value of “0” or “1”. On-off keying (OOK) denotes the simplest form of amplitude-shift keying (ASK) modulation that represents digital data by a presence or absence of a carrier wave. This scheme is the simplest form of digital modulation, where the signal amplitude is changed from 0 to 100%. In other words, when the magnitude of the signal amplitude is 50% or less, it is recognized as a value of “0”, and when the magnitude of the signal amplitude is more than 50%, it is recognized as a value of “1”.

Modulating the amplitude of the signal indicates that the transmitting current at the reduced signal level is also lower. The power consumption of an OOK transmitter may be 50% lower than of a Frequency-Shift keying (FSK) or a Phase-Shift keying (PSK) transmitter. Notably, a field generation strongly depends on a bandwidth (i.e. Q factor) of the coil. If it is too narrow, the receiver might not be able to decode the data correctly. Coils with high Q values need more periods to reach the desired field strength and, hence, appropriate detection level thresholds in the receiver. Thus, the Q factor should be adapted to ensure proper data communication. For example, the thresholds may be chosen at 70% of the required output current for a detection of a transition from 0 to 1 and at 30% for a detection of a transition from 1 to 0.

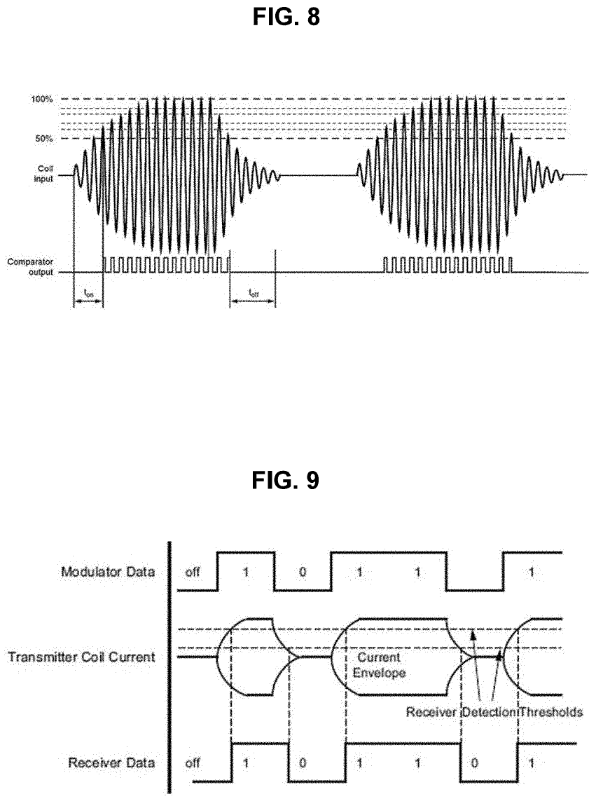

An example of an OOK waveform timing is shown in FIG. 8. FIG. 8 shows a typical response in case that a resonance circuit is turned on by applying a drive signal and, after some time, the resonance circuit is switched off again. FIG. 9 shows exemplary waveforms of a current in a transmitter coil and a received signal detected by a receiver according to the OOK modulation. FIGS. 8 and 9 shows that the amplitude of oscillations increases rapidly upon start-up. There is some finite time required for the resonance to start-up and reach the eventual maximum amplitude. There is similarly a finite time required for the resonance oscillations to decrease to some desired level. The rising and falling times will be the predominant factors in choosing a baud rate. The Manchester code may be used to encode modulated signals.

The LF receiver is an ultra-low-power ASK receiver for LF bands. Without a carrier signal, it operates in standby listen mode. In this mode, the LF receiver monitors the coil input with a very low current consumption. On the other hand, the low power excitation (LPE) may be used for a communication between the supply device 100 and the EV device 200 in such a way that the primary device 130 emits the LPE signal and the secondary device 230 detects the LPE signal.

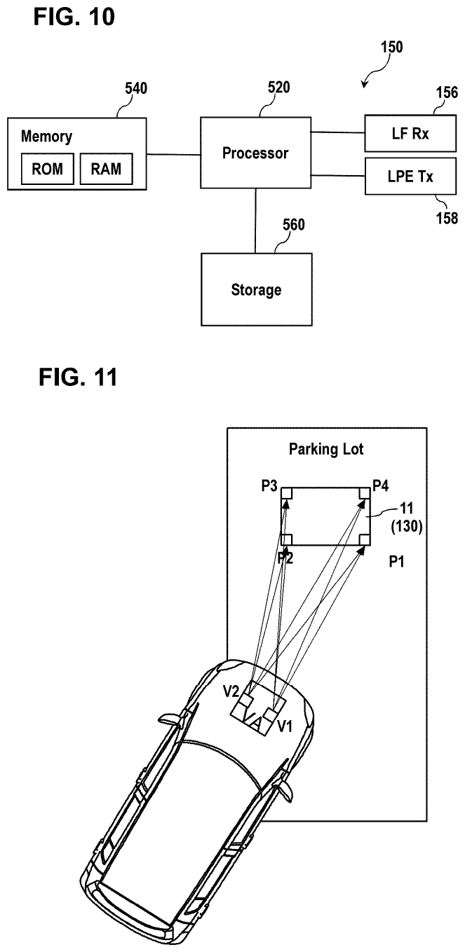

FIG. 10 is a physical block diagram of the supply WPTCC 150 according to an exemplary embodiment of the present disclosure. Referring to FIG. 10, the supply WPTCC 150 according to an exemplary embodiment of the present disclosure may include at least one processor 520, a memory 540, and a storage 560. In addition, the supply WPTCC 150 may include one or more LF receivers 156 and one or more LPE transmitters 158.

The processor 520 may be configured to execute program instructions stored in the memory 520 and/or the storage 560. The processor 520 may be a central processing unit (CPU), a graphics processing unit (GPU), or another kind of dedicated processor suitable for performing the methods of the present disclosure. The memory 540 may include, for example, a volatile memory such as a read only memory (ROM) and a nonvolatile memory such as a random access memory (RAM). The memory 540 may load the program instructions stored in the storage 560 to provide to the processor 520.

The storage 560 may include a non-transitory computer readable medium suitable for storing the program instructions, data files, data structures, and a combination thereof. Any device capable of storing data that may be readable by a computer system may be used for the storage. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD).

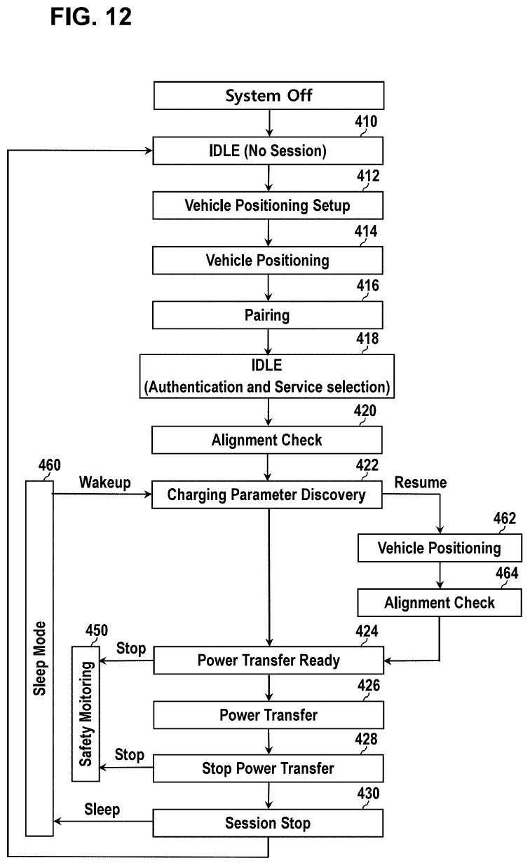

The storage 560 may store the program instructions. In particular, the program instructions may include program instructions for wireless power transfer according to the present disclosure. The program instructions for the wireless power transfer includes program instructions required to implement the communication interfaces 154, 160, and 162 shown in FIG. 5. In addition, the program instructions for the wireless power transfer may include at least some of the instructions required to implement the process shown in FIG. 12. Such a program instructions may be executed by the processor 520 while being loaded into the memory 540 under the control of the processor 520 to implement the method according to the present disclosure.

Meanwhile, the functions of the one or more LF receivers 156 and the one or more LPE transmitters 158 are the same as those described in connection with FIG. 6, and detailed description of them are omitted for simplicity. Meanwhile, the EV WPTCC 250 also has a configuration similar to that of the supply WPTCC 150. Since the EV side WPTCC 250 may be easily implemented by a person skilled in the art based on the description of the present specification, detailed description of the EV WPTCC 250 will be omitted also.

Protocols and Operations

Referring to FIG. 11, a concept of an exemplary vehicle positioning and alignment using the LF signals are described briefly. As mentioned above, as the transmitter coil L1 in the transmitter pad 11 and the receiver coil L2 in the receiver pad 21 are located farther away, the power loss increases and the power transfer efficiency is reduced. Thus, the two coils L1 and L2 needs to be arranged to be proximate to each other. Vehicle positioning may be performed so that the two coils L1 and L2 are brought to be close (e.g. abutting), and alignment may be performed so that the two coils L1 and L2 face with each other.

First, it is assumed that the four receivers P1-P4 are arranged symmetrically around the magnetic structure of the primary device 130 in the supply device 100, and the two transmitters V1 and V2 are arranged symmetrically around the magnetic structure of the secondary device 230 in the EV 20. In such a state, when a vehicle approaches a specific parking area for charging, a frequency for a particular parking lot selected by the SECC 140 may be notified to the EV through a WLAN link. The EV device 200 may be configured to transmit a corresponding trigger signal to the supply device 100 at the selected frequency. The SECC 140 may be configured to transmit back a received signal strength intensity (RSSI) detected by a sensor to the EVCC 240. Thus, a position estimation algorithm may be performed by the EV device 200 based on the RSSI fed back by the supply device 100.

The EV device 200 may be configured to request the vehicle positioning using the LF signal. The SECC 140 receiving the vehicle positioning request may be configured to instruct the supply WPTCC 150 to turn on the LF signal receiver 160, and provide the EV device 200 with the frequency information. Accordingly, the EV WPTCC 250 may be configured to turn on the LF signal transmitter 260 to start the P2PS communication using the LF signal.

When the driver moves the vehicle to a particular parking space, that is, a charging space and the receiver pad 21 approaches within about 4 to 6 meters, for example, of the transmitter pad 11, the LF signal receivers P1-P4 of the supply device 100 may be configured to measure the LF signal transmitted by the transmitters V1 and V2 of the EV device 200. The SECC 140 of the supply device 100 may be configured to transmit measured values to the EVCC 240 of the EV device 200 through the WLAN, and the EVCC 240 may be configured to determine the position of the transmitter pad 11 using the measured values. The vehicle positioning and alignment can proceed based on repetitive measurements of the LF signals.

FIG. 12 is a flowchart illustrating an example of a wireless power transfer (WPT) process according to an exemplary embodiment of the present disclosure. Referring to FIG. 12, the operation of the WPTCCs 150 and 250 in the context of an application layer protocol is described in detail by specifying the communications between the supply WPTCC 150 an the SECC 140 and between the EV WPTCC 250 and the EVCC 240. Additionally, described are how the WPTCC 150 and 250 operate the power circuits 110 and 210 and the P2PS communications based on the communication with the SECC 140 and the EVCC 240.

The supply device 100 and the EV device 200 may be configured to turn on the WPT system at the time of start, and wait for a new session to start (operation 410). In particular, the SECC 140 may be configured to prepare a charging session by setting up a wireless access point and waiting for a new connection request from a vehicle. When a vehicle arrives at the charging station, the EVCC 240 of the vehicle associates with an SECC 140 according to a procedure specified in the ISO 15118-8:2018 standard and starts a communication according to a transport layer security (TLS) protocol with the SECC 140. After the SECC 140 and EVCC 240 negotiates the protocol version, a new session starts.

When the customer wants to use a WPT-based charging service, the EVCC 240 of the vehicle starts a vehicle positioning setup process (operation 412). In this process, the EVCC 240 and the SECC 140 agree upon vehicle positioning setup methods and related parameters. During this process, the EVCC 240 and the SECC 140 may be configured to request information necessary for the vehicle positioning setup such as supported methods and related parameters from the EV WPTCC 250 or the supply WPTCC 150, respectively. In response to receiving the request, the WPTCC 250 or 150 provides the positioning parameters to the EVCC 240 and the SECC 140.

After the vehicle positioning setup of operation 412, the EV device 200 and the supply device 100 perform vehicle positioning (operation 414). The vehicle positioning typically begins with the EV's approaching a designated WPT spot with an aim of ensuring that the secondary and primary devices 230 and 130 are positioned within an alignment tolerance area. The vehicle positioning operation may be performed in one of three types: manual positioning, LF positioning, and LPE positioning. The method to use may be determined during the vehicle positioning setup operation.

The vehicle positioning operation may include a fine positioning operation which performs an “adjust position” action. The “adjust position” action is typically a loop exchanging updated data related to changing vehicle positions until the secondary device 230 is within the alignment tolerance area. When the positioning procedure is initiated, the EVCC 240 and the SECC 140 indicates the start of the process to the WPTCCs 250 and 150, respectively, through the communication interfaces 254 and 154. When the vehicle positioning is completed, EVCC 240 and the SECC 140 also indicates the completion of the procedure to the WPTCCs 250 and 150. During the manual fine positioning, the driver of the EV is expected to maneuver the EV without any technical support from the supply device 100. The progressing state of the fine positioning, however, is exchanged through communications.

The vehicle positioning using the LF signal is performed by applying the LF signal. First, the supply device 100 may be configured to prepare the LF receiver 160 to receive the LF signal from the EV WPTCC 250. Then, the SECC 140 may be configured to respond to the EVCC 240 by transmitting a message containing the LF operating frequency information for a specific parking spot. The EV device 200 may be configured to transmit an LF trigger signal to the LF receiver 160 of the supply device 100 through the P2PS link at the selected frequency. If the driver moves the EV to the charging spot and the secondary device 230 approaches within a certain minimum distance, for example, about 4 meters from the primary device 130, the LF receiver 160 may be configured to detect the LF signal transmitted by the EV WPTCC 250. Subsequently, the EV device 200 may be configured to transmit the LF signal for positioning to the supply device 100, and the EVCC 140 may be configured to request the SECC for a message containing pre-calibrated raw data. Accordingly, the SECC 140 may respond to the EVCC 240 with a message containing the RSSI values of the LF signal received by the supply device 100 as the pre-calibrated raw data. By use of these detected values, the EV device 200 may be configured to dynamically calculate the position of the primary device 130.

Once the secondary device 230 is over the primary device 130 within the alignment tolerance area and the primary device 130 and the secondary device 230 are in a “good” alignment, the EV will stop and park, and the vehicle positioning process is finished. The supply device 100 no longer activates the LF receiver 160 until a new session is started, and responds to the EVCC 240 by transmitting a message indicating that the LF receiver is no longer active.

In case of the positioning using the low power excitation (LPE), the supply device 100 may be configured to generate the magnetic field and the EV device 200 may be configured to detect the magnetic field. The EV device 200 may be configured to detect the magnetic signal and use this signal to generate distance values to the supply device 100. In the LPE-based positioning, it is important to generate a detectable but safe magnetic field. After successful fine positioning, a pairing activity may be performed to allow both the SECC 140 and the EVCC 240 to uniquely identify the primary device 130 on which the EV is placed on (operation 416). One secondary device 230 is uniquely paired to one primary device 130 through the pairing operation.

There may be a plurality of supply devices 100 may be arranged in a charging station and a plurality of supply power circuits 110 may be connected to the SECC 140 of each supply device 100, but the EV device 200 must be paired to the SECC 140 connected to the primary device 130 which the EV is actually parked thereon. Pairing may be performed by detecting and analyzing a specific modulated signal after the supply WPTCC 250 receives the LF signal transmitted by the EV WPTCC 150. The modulated signal has a predetermined coding pattern and allows the primary device 130 in the WPT charging station to be uniquely identified.

After successful vehicle positioning and pairing, the WPT system enters an idle mode until the EVCC 240 and the SECC 140 trigger an alignment check process (operation 418). During this idle period, the EVCC 240 and the SECC 140 may be configured to perform an authentication procedure to agree on an identification method (either EIM or PnC), for example. After the authentication, EVCC 240 and SECC 140 agree upon a set of services including charging services and additional services, as necessary.

Next, an alignment check operation may be performed to determine whether the alignment of the primary device 130 and the secondary device 230 is within the range of the alignment tolerance area (operation 420). To increase a transmission efficiency and safety, the alignment check may be performed whenever the power transfer starts. When checking the alignment, whether an proper alignment has been achieved or not may be confirmed by analyzing and comparing the RSSI values which the EV received from the supply WPTCC 150, and verified additionally by the supply device 100 by checking a target voltage, efficiency, and coupling by use of the LPE signal.

Subsequently, the EVCC 240 and the SECC 140 negotiate the charging parameters. The EVCC 240 may be configured to provide its charging parameters to the SECC 140, and the SECC 140 may be configured to provide applicable charging parameters from the supply device 100 (operation 422). The charging parameter discovery is defined, for example, in technologies specific parts of the ISO 15118 standard series. To support this process, the WPTCC may provide communication interfaces to provide parameters needed by the EVCC 240 and the SECC 140.

After the charging parameter discovery, EVCC 240 may be configured to commit to power transfer in a power delivery process. This triggers the EVCC and the SECC to indicate the WPTCCs 250 and 150 to prepare power transfer by activating the power circuits 210 and 110 and starting safety monitoring (step 424). If the safety monitoring system is running without a problem or encounter any problem or malfunctions, the WPTCCs 250 and 150 notifies the EVCC 240 and the SECC 140 of the result.

After successfully processing the “prepare power transfer” operation, the EVCC 240 may be configured to request “start power transfer” to the WPTCC 150, which will then command the power circuit 110 accordingly (operation 426). Additionally, after receiving the power request from the EVCC 240, the SECC 140 may be configured to request “start power transfer” to the WPTCC 150, which will then command the power circuit 110 accordingly. The WPT system may be configured to perform the power transfer between the primary device 130 and the secondary device 230 upon the request from the EVCC 240. The supply device 100 may be configured to exchange information by a communication with the EVCC 240 to perform the power transfer to the EV device 200. After successfully performing the “prepare power transfer” operation, the EVCC 240 may be configured to request a change to perform the power transfer power via communications. After receiving the power request from the EVCC 240, the SECC 140 may have to respond to the request within a predetermined time. During the power transfer, the supply device 100 and the EV device 200 perform an abnormality monitoring.

When the EVCC 240 does not want power being transferred either to finish the session or to temporarily cease the transfer, the EVCC 240 indicates that to the SECC 140 and requests “stop power transfer” to the WPTCC 250, which will then command the power circuit 210 accordingly. When the SECC 140 receives the stop power transfer request, the SECC 140 may be configured to “stop power transfer” to the WPTCC 150, which will then command the power circuit 210 (operation 428). In response to stopping the power transfer, the WPTCC 250 may be configured to terminate the safety monitoring process. Even in the state that the power transfer is stopped, the communications between the supply device 100 and the EV device 200 is not terminated and the WPT spot still may be occupied by the EV. Additionally, power equipment is not necessarily disabled when power transfer is interrupted.

When the EVCC 240 wants to stop the current session, the EVCC 240 may be configured to notify the SECC 140 and provide an indication thereof to the WPTCC 250, which will then command to the power circuit 210 (operation 430). When the SECC 140 receives a message from the EVCC 240, the SECC 140 may also be configured to request the WPTCC 150, which will then command to the power circuit 110. Optionally, the WPTCC 150 may be configured to detect when the vehicle leaves the charging point. In particular, the WPTCC 150 of the supply device 100 may be configured to provide a notification regarding the removal of the EV to the SECC 140. When the session is terminated in the operation 430, the procedure may return to the operation 410, and the supply device 100 and the EV device 200 wait for a new session to start.

Meanwhile, the supply device 100 and the EV device 200 may be in a standby state where the power transfer is completely stopped while the communications between them are continued (operation 450). When entering the standby state, the SECC 140 and the EVCC 240 instruct the WPTCCs 150 and 250 to stop the power transfer until the transfer resumes. The standby state is suitable in a condition where it is probable that the power transfer is just temporarily interrupted, for example, in case of an interruption for a safety monitoring.

Further, the supply device 100 and the EV device 200 may be in a sleep mode or a pause mode. In the sleep or pause mode, the EVCC 240 and the SECC 140 completely terminate the communication link and power transfer operation. When the EVCC 240 and the SECC 140 enter the pause mode, the EVCC 240 and the SECC 140 indicate the WPTCCs 250 and 150, respectively, which will then command the power circuit 110 and 210 to enter a power-save mode.

When the EVCC 240 and the SECC 140 want to wake up from the pause mode and resume the session either due to a planned schedule or an unexpected event, the EVCC 240 and the SECC 140 will command the WPTCCs 150 and 250 to wake up the power circuits 110 and 210. Then, the charging procedure may be resumed along with the “charging parameter discovery” process. In some cases, the positioning and alignment check operations may be performed (operations 454 and 456).

As mentioned above, the apparatus and method according to exemplary embodiments of the present disclosure may be implemented by computer-readable program codes or instructions stored on a non-transitory computer-readable recording medium. The non-transitory computer-readable recording medium includes all types of recording media storing data readable by a computer system. The non-transitory computer-readable recording medium may be distributed over computer systems connected through a network so that a computer-readable program or code may be stored and executed in a distributed manner.

The non-transitory computer-readable recording medium may include a hardware device specially configured to store and execute program commands, such as ROM, RAM, and flash memory. The program commands may include not only machine language codes such as those produced by a compiler, but also high-level language codes executable by a computer using an interpreter or the like.

Some aspects of the present disclosure have been described above in the context of a device but may be described using a method corresponding thereto. In particular, blocks or the device corresponds to operations of the method or characteristics of the operations of the method. Similarly, aspects of the present disclosure described above in the context of a method may be described using blocks or items corresponding thereto or characteristics of a device corresponding thereto. Some or all of the operations of the method may be performed, for example, by (or using) a hardware device such as a microprocessor, a programmable computer or an electronic circuit. In some exemplary embodiments, at least one of most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A wireless power transfer device for supplying energy to an electric vehicle through an electric vehicle (EV) device in the electric vehicle, comprising:
a supply power circuit configured to form a magnetic flux from source power and supply the energy to the EV device through the magnetic flux;
a supply device communication controller (SECC) configured to communicate with the EV device; and
a supply wireless power transfer communication controller (WPTCC) configured to perform a peer-to-peer signal (P2PS) communication with the EV device, under an operation of the SECC, to transmit and receive data required for positioning, pairing, and alignment check and operate the supply power circuit.

2. The wireless power transfer device of claim 1, wherein the SECC is configured to perform a communication with the EV device in an application layer.

3. The wireless power transfer device of claim 2, wherein operations performed in the supply power circuit and operated by the supply WPTCC include: ‘turning on’, ‘turning off’, ‘entering sleep mode’, ‘wake up from sleep mode’, ‘start wireless charging’, and ‘stop wireless charging.

4. The wireless power transfer device of claim 3, wherein the P2PS communication with the EV device is performed using at least one of a low frequency magnetic field (LF) signal and a low power excitation (LPE) signal.

5. The wireless power transfer device of claim 4, wherein the supply WPTCC is configured to receive commands related to positioning, pairing, and alignment check from the SECC to perform the P2PS communication in response to the commands.

6. The wireless power transfer device of claim 3, wherein the supply power circuit includes:
a supply power electronics circuit configured to convert a frequency and level of the supply power and cause a resonance to occur; and
a primary device configured to receive a converted power signal from the supply power electronics circuit and form the magnetic flux,
wherein the supply WPTCC directly operates the supply power electronics circuit.

7. The wireless power transfer device of claim 1, wherein the SECC and the supply WPTCC separately includes a first and a second processors, respectively.

8. The wireless power transfer device of claim 7, wherein the supply WPTCC includes:
at least one low-frequency (LF) receiver configured to receive an LF signal from the EV device;
at least one LPE transmitter configured to transmit an LPE signal to the EV device;
the second processor; and
a memory configured to store at least one instruction executable by the second processor,
wherein the at least one instruction includes:
an instruction for interfacing communications with the SECC;
an instruction for receiving the LF signal through the at least one LF receiver and transmitting the LPE signal through the at least one LPE transmitter; and
an instruction for operating the supply power circuit.

9. A wireless power transfer device installed in an electric vehicle for receiving energy from an external supply device to charge an energy storage device, comprising:
an electric vehicle (EV) power circuit configured to receive the energy from the supply device through a magnetic flux to convert to electrical power and charge the energy storage device;
an EV communication controller (EVCC) configured to communicate with the supply device; and
an EV wireless power transfer communication controller (WPTCC) configured to perform a peer-to-peer signal (P2PS) communication with the supply device, under an operation of the EVCC, to transmit and receive data required for positioning, pairing, and alignment check and control the EV power circuit.

10. The wireless power transfer device of claim 9, wherein the EVCC is configured to perform a communication with the supply device in an application layer.

11. The wireless power transfer device of claim 10, wherein operations performed in the EV power circuit and operated by the EV WPTCC includes: ‘turning on’, ‘turning off’, ‘entering sleep mode’, ‘wake up from sleep mode’, ‘start wireless charging’, and ‘stop wireless charging.

12. The wireless power transfer device of claim 11, wherein the P2PS communication with the supply device is performed using at least one of a low frequency magnetic field (LF) signal and a low power excitation (LPE) signal.

13. The wireless power transfer device of claim 12, wherein the EV WPTCC is configured to receive commands related to positioning, pairing, and alignment check from the EVCC to perform the P2PS communication in response to the commands.

14. The wireless power transfer device of claim 11, wherein the EV power circuit includes:
a secondary device configured to convert the magnetic flux to an induction power signal; and
an EV power electronics circuit configured to convert a level of the induction power signal and rectify a level-converted signal to charge the energy storage device,
wherein the EV WPTCC directly operates the EV power electronics circuit.

15. The wireless power transfer device of claim 11, wherein the EVCC and the EV WPTCC separately includes a first and a second processors, respectively.

16. The wireless power transfer device of claim 15, wherein the EV WPTCC includes:
at least one LF transmitter configured to transmit an LF signal to the supply device;
at least one LPE receiver configured to receive an LPE signal from the supply device;
the second processor; and
a memory configured to store at least one instruction executable by the second processor,
wherein the at least one instruction includes:
an instruction for interfacing communications with the EVCC;
an instruction for transmitting the LF signal through the at least one LF transmitter and receiving the LPE signal through the at least one LPE receiver; and
an instruction for controlling the EV power circuit.
